(19) United States
(12) Patent Application Publication
(10) Pub. No.: US 2008/0253399 A1
(43) Pub. Date: Oct. 16, 2008

(54) OPTIMIZATION METHODS AND APPARATUS FOR TRANSMITTING MULTIPLE PLMN-IDS

(75) Inventors: Peter S. Wang, E. Setauket, NY (US); Jin Wang, Central Islip, NY (US); Stephen E. Terry, Northport, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 12/103,425

(22) Filed: Apr. 15, 2008

Related U.S. Application Data
(60) Provisional application No. 60/912,068, filed on Apr. 16, 2007.

(51) Int. Cl. H04J 3/00

(52) U.S. Cl. 370/477; 455/456.1

(57) ABSTRACT

This application is related to a method and apparatus for optimizing the transmission of PLMN-IDs in a wireless network. This is accomplished by reducing the amount of bandwidth required to transmit a given set of PLMN-IDs.

### CROSS REFERENCE TO RELATED APPLICATIONS

This application claims the benefit of U.S. Provisional Application Ser. No. 60/912,068 filed on Apr. 16, 2007, which is incorporated by reference as if fully set forth.

### FIELD OF INVENTION

The present invention is related to wireless communication systems. More particularly, the present invention is related to methods of optimizing the transmission of multiple public land mobile network identifiers (PLMN-ID)s by compressing one or more PLMN-ID components.

### BACKGROUND

The third generation partnership project (3GPP) has initiated the Long Term Evolution (LTE) program to bring new technology, new network architecture, new configuration and new applications and services to the wireless cellular network in order to provide improved spectral efficiency and faster user experiences. As part of that program, LTE system information on the evolved-Universal Mobile Telecommunications Service (UMTS) Terrestrial Radio Access Network (E-UTRAN) should also support the network sharing feature by publishing multiple Public Land Mobile Network-Identifiers (PLMN-IDs) on the broadcast channels (BCH) on each of the LTE cells, and therefore on the primary-BCH (P-BCH) or dynamic-BCH, often enough so that a wireless transmit/receive unit (WTRU) can receive the PLMN-IDs in time to decide which PLMN it should access.

A PLMN-ID consists of a mobile country code (MCC) component and a mobile network code (MNC) component. A MCC may range numerically from 0 to 999. Therefore, a 10-bit field is required to represent (store) this 3-digit number. A MNC may also range from 0 to 999. It could be a 2 or 3-digit number. To facilitate network sharing in LTE, as well as other types of networks such as UMTS, a list of PLMN-IDs should be broadcasted to all of the wireless WTRUs in a cell.

UMTS Release-6 and 3GPP Work Group 2 proposals specify that multiple PLMN-IDs should be transmitted in the system information broadcast in the Master Information Block or the Broadcast Channel (BCH). In UMTS the MCC is marked OPTIONAL. If the PLMN-ID's MCC is the same as a previous PLMN-ID's MCC, then the MCC is not repeated in the message. Consequently, the present/not-present indicator takes one-bit in the formatted message, as shown in Table 1.

TABLE 1
Prior Art for multiple PLMN-ID List formatting

| MCC field value | MCC field length | Comment |
|---|---|---|
| MCC1 | 10-bit | |
| MCC2 | | Presence bit (P-bit) exist in |
| | | Abstract Syntax Notation.One |
| | | (ASN.1) form, if 1, |
| | | field length = 10, |
| | | if 0, MCC2 == MCC1, MCC-2 |
| | | is not sent, and field length = 0 |
| MCC3 | 10-bit | Same as above |
| ;;; | 10-bit | ;; |
| MCCn | 10-bit | ;; |

In LTE, P-BCH bandwidth is very limited. Sending up to a maximum of 6 PLMN-IDs in a system block on the P-BCH is considered very expensive. Therefore, it would be desirable to optimize the use of bandwidth for efficient transmission of multiple PLMN-IDs.

### SUMMARY

This application is related to a method and apparatus for optimizing the transmission of PLMN-IDs in a wireless network. This is accomplished by reducing the amount of bandwidth required to transmit a given set of PLMN-IDs.

### BRIEF DESCRIPTION OF THE DRAWINGS

A more detailed understanding may be had from the following description, given by way of example in conjunction with the accompanying drawings wherein:

FIG. 1 is a flow chart of a method for optimizing PLMN-ID field lengths; and

FIG. 2A-2B is a flow chart of an alternative method of optimizing PLMN-ID field lengths using deltas.

FIG. 3 shows one example of an implementation of an embodiment in a WTRU.

FIG. 4 illustrates an embodiment in wireless network with different WTRUs (mobile device and an evolved Node B).

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, a base station, or any other type of device capable of operating in a wireless environment. When referred to hereafter, the terminology “base station” includes but is not limited to a Node-B, an evolved Node-B, a site controller, an access point (AP), or any other type of interfacing device capable of operating in a wireless environment. When referred to hereafter, the terminology “format” is used interchangeably with the word “store.” When referred to hereafter, the terminology “data” refers to any type of information including but not limited to PLMN-IDs, PLMN-ID components, MNCs, MCCs, numbers, numerical identifiers, numerical values, symbols, symbolic values, etc. Throughout this application, the use of following notation: MCC-n and MCCₙ, are equivalent and interchangeable.

A MCC may have a value ranging from 0 to 999. Therefore, the minimum field length required to represent (store) a given MCC is 10-bits. However, not every MCC needs a full 10-bit field to convey its value. For example, a MCC of 111 may be stored in a 7-bit field. By using ┌Log₂ MCC┐ (a ceiling function for rounding up to the next smallest integer, e.g.: 3.23 to 4), the field length required to store a MCC may be reduced to less than 10 bits. Moreover, this technique does not require a field length indicator to be sent to a receiver (WTRU, mobile phone, etc.). A receiver, may predict the actual field length by using the following property: if a≧b≧0 then log₂ a≧log₂ b.

Since log₂ a≧log₂ b, multiple PLMN-IDs can be sorted into descending order, such that MCC-a is greater than or equal to MCC-b, and so on. When the first PLMN-ID is transmitted, it will contain MCC-a and the MCC-a component of the PLMN-ID will use the largest possible MCC field length (10-bits) and each subsequent PLMN-ID is transmitted containing a different MCC (say MCC-b) using a field length derived from the previous MCC value, ┌Log₂ MCC-a┐-bit field length. Therefore, each of the subsequent MCCs will use a field length derived from the previous MCC that is always less than or equal to the conventional 10-bit fixed field length. As previously noted, this solution also eliminates the need for a separate length indicator when transmitting PLMN-IDs. Thus, the field length of a given PLMN-ID (other than the first PLMN-ID with largest MCC) is reduced, and the aggregate field length and the time required for the transmission of PLMN-IDs is reduced.

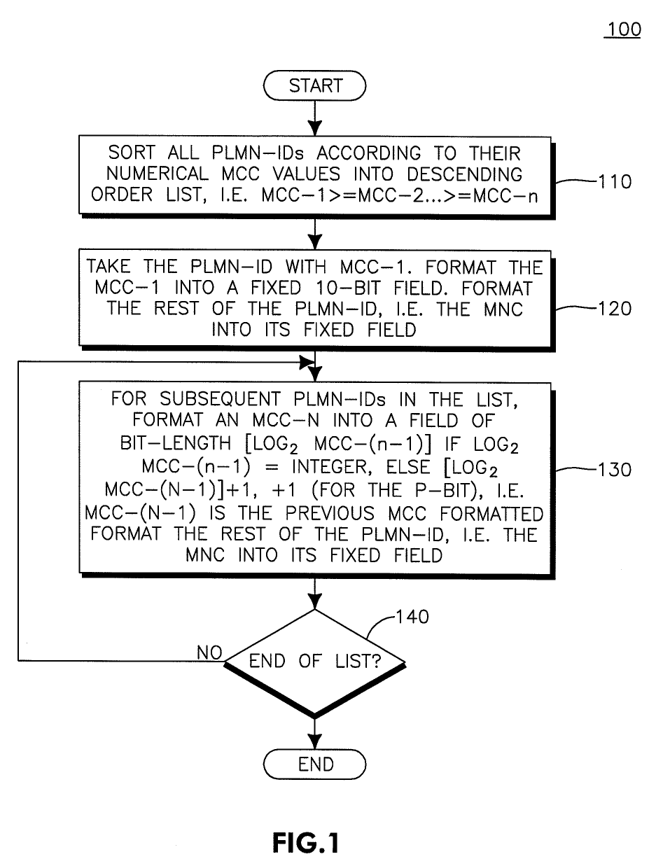

FIG. 1 displays an example of a method in accordance with one embodiment. At step 110, all PLMN-IDs are sorted based upon their respective MCC into descending numerical order, such that MCC-1>=MCC-2>=. . . >=MCC-n and so on, into a list (e.g.: a table or equivalent structure). This results in a list of PLMN-IDs [MCC-1, . . . MCC-n], where n is less than or equal to six (6) (the value six (6) is based upon existing standards, however, this embodiment works equally well with any value of n), with MCC-1 having the greatest MCC value. At step 120, the MCC field of the first PLMN-ID (the one containing MCC-1) is formatted (stored) into a 10-bit field. Next, the rest of the PLMN-ID (the MNC) is stored into a corresponding fixed field (since the MNC can be a 2 or 3 digit number, the length of the MNC field will be 7-bits or 10-bits and may also require an additional one or two bit length indicator). At step 130, the MCC field of the next PLMN-ID (the one containing MCC-2) is stored into a field of length ┌Log₂ MCC-1┐ if Log₂ MCC-1 is not an integer, otherwise the MCC field of the next PLMN-ID (MCC-2) is stored into a field of length ┌Log₂ MCC-1┐+1. Then the corresponding MNC (the rest of the PLMN-ID) is stored into its fixed field. Next, the MCC field of the next PLMN-ID (the one containing MCC-3) is stored into a field of length ┌Log₂ MCC-2┐ if Log₂ MCC-2 is not an integer, otherwise the MCC field of the next PLMN-ID (the one containing MCC-3) is stored into a field of length ┌Log₂ MCC-2┐+1, then the corresponding MNC is stored into its fixed field and so on until the end of the list is reached at step 140. In general, the MCC field of PLMN-ID-n (the one containing MCC-n) is formatted (stored) into a field of length ┌Log₂ MCC-(n−1)┐ if Log₂ MCC-(n−1) is not an integer, otherwise the MCC field of PLMN-ID-n (the one containing MCC-n) is stored into a field of length ┌Log₂ MCC-(n−1)┐+1. In every case, the full field length of a PLMN-ID will be the sum of the following:

1 bit (for the p-bit);

┌Log₂ MCC-(n−1)┐ bits if Log₂ MCC-(n−1) is not an integer, or otherwise ┌Log₂ MCC-(n−1)┐+1 bits; and

the field length, in bits, of the MNC field.

TABLE 2
Implicit MCC Field Length Reduction
illustration (without MNC or p-bit)

| MCC field value | MCC field length | Comment |
|---|---|---|
| MCC-1 | 10-bit | Greatest MCC value |
| MCC-2 | ┌Log₂ MCC-1┐ if | Presence bit (P-bit) |
| | Log₂ MCC-1 ≠ integer, else | still exist |
| | ┌Log₂ MCC-1┐+1 | |
| MCC-3 | ┌Log₂ MCC-2┐ if | Presence bit (P-bit) |
| | Log₂ MCC-2≠ integer, else | still exist |
| | ┌Log₂ MCC-2┐+1 | |
| ; ; ; | | Presence bit (P-bit) |
| | | still exist |
| MCC-n | ┌Log₂ MCC-(n−1)┐ if | Presence bit (P-bit) |
| | Log₂ MCC-(n−1)≠ integer, | still exist |
| | else | |
| | ┌Log₂ MCC-(n−1)┐+1 | |

After this processing completes the list is transmitted to one or a plurality of mobile devices (WTRU, mobile phone, etc.). In general, for MCC-2, the field length saving is (10−┌Log₂ MCC-1┐), for MCC-3 the field length saving is (10−┌Log₂ MCC-2┐) and for MCC-n the field length saving is (10−┌Log₂ MCC-(n−1)┐). The combined savings achieved by this optimization method can be expressed as

$$[ ( N - 1 ) \times 10 - {\sum }_{m = 1}^{n - 1} {Log}_{2} {MCC}_{m} ) ] .$$

Therefore, if the individual MCC values in the multiple PLMN-ID list are numerically small, that is, less than or equal to 255 (7-bits), then this method is very efficient.

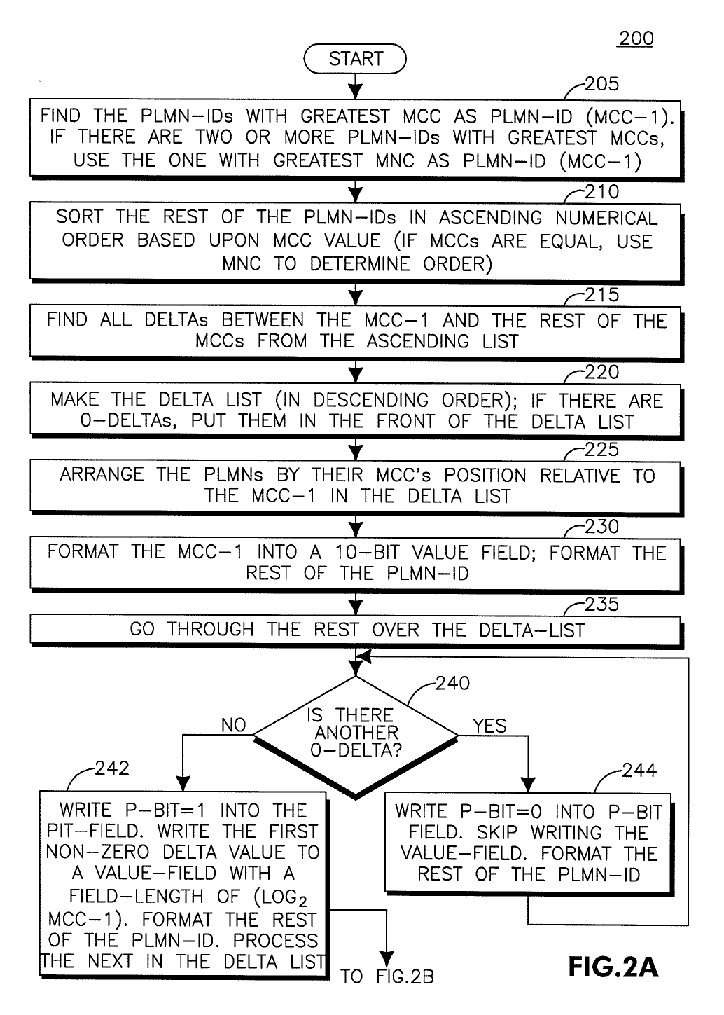

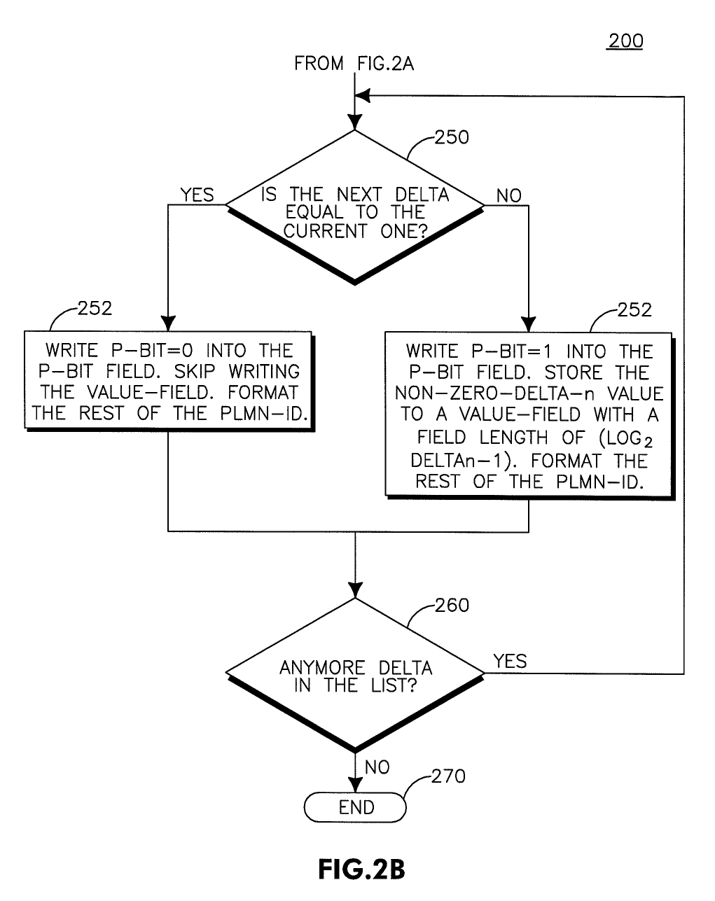

Referring now to FIG. 2, if the individual values of MCCs in the multiple PLMN-ID List are in the high value range, that is, greater than or equal to 256, while the value differences between them are relatively small (less than or equal to 63), another embodiment shown in FIG. 2 may be used. This embodiment results in a delta/offset field length that will be smaller than the typical field length required to store a MCC value in a PLMN-ID transmission.

The method 200 begins at step 205 in FIG. 2A, where given a list of PLMN-IDs, the method sets MCC-1 to the MCC value of the PLMN-ID in the list containing the largest MCC (the one with the greatest numerical value). If more than one greatest MCC exists, the one with the largest MNC is chosen. At step 210, the rest of the PLMN-IDs are sorted in ascending order based upon their respective MCC value such that MCC-2≦MCC-3≦ . . . ≦MCC-n (if any PLMN-IDs have MCCs that are equal, then they are placed in the list in ascending order based upon their respective MNC value). At step 215, the value differences or deltas δ_{MCC-1,m} (m=2, . . . , n) between MCC-1 and each of the other MCCs (e.g.: δ_{MCC-1,2}=MCC-1−MCC-2) are calculated and at step 220, each result is stored into a delta-list (e.g.: a table or equivalent structure) in descending order, such that, δ_{MCC-1,2}>=δ_{MCC-1,3}>=, . . . , δ_{MCC-1,n}, where n=2, 3, . . . , N (where N≦6 in LTE). In particular if there are deltas (δ_{MCC-1,m}) equal to 0, which means that some MCCs are equal to MCC-1, then the zero-delta(s) are placed in the front of the delta-list, such that δ_{MCC-1,2}=0, δ_{MCC-1,3}>=δ_{MCC-1,4}>=, . . . , δ_{MCC-1,n}; this condition only occurs if one or more sequential delta values, beginning with the second delta value, are zero (one or more MCCs are equal to MCC-1).

At step 225, the multiple PLMN-IDs are arranged starting with MCC-1 and the rest according to their order in the delta-list, such that [MCC-1, MCC-2 . . . MCC-n], where n is <=6 (typically, n=5 or 6 in LTE or WCDMA respectively, however, this embodiment will work with any value for n) and that MCC-2=MCC-1−δ_{MCC-1,2}, MCC-3=MCC-1δ_{MCC-1,3}, and so on. The aranging procedure may use a new list. In general, MCC-n=MCC-1−δ_{MCC-1,n}; utilizing this relationship, a receiver is able to derive the MCC values from the transmitted MCC-1 and the transmitted deltas.

At step 230, the MCC-1 is formatted (stored) into a 10-bit field and the rest of the PLMN-ID (the MNC component) is stored in a corresponding additional field (the total field length will be 10 bits+the length required to store the MNC component). The p-bit is not in the MCC-1 entry.

At steps 240 and 244, any zero-delta, for example, δ_{MCC-1,2}, MCCs are formatted by setting the presence-bit to 0 (no MCC or delta values are stored in the field (i.e.: a field length=0)), if any zero-delta-MCCs exist, the rest of the PLMN-ID (the MNC component) is stored in a corresponding additional field (thus the total field length for a PLMN-ID in this case is the length required to store the MNC component +1 (for the p-bit));

At step 242, the first non-zero delta, say δ_{MCC-1,3} is formatted into a ┌Log₂ MCC-1┐ length field, if (Log₂ MCC-1) is not an integer, otherwise the first non-zero delta is formatted into a ┌Log₂ MCC-1┐+1 length field, the presence bit (p-bit) is set to 1 and the rest of the PLMN-ID (the MNC component) is stored in a corresponding additional field (the total field length will be ┌Log₂ MCC-1┐ bits if (Log₂ MCC-1) is not an integer, otherwise the total field length will be ΠLog₂ MCC-1┐+1 bits, + the length required to store the MNC component +1 bit (for the p-bit));

Continuing in FIG. 2B at step 260, subsequent deltas are formatted (until the end of the list is reached) such that:

At step 250, if the δ_{MCC-1,n} equals the previous delta δ_{MCC-1,(n-1)}, at 252, the presence bit is set to 0, a delta value is not stored (no bits are used to store the delta value, e.g. a 0-bit field length) and the rest of the PLMN-ID (the MNC component) is stored in a corresponding additional field (the total field length in this case is the length required to store the MNC component +1 bit (for the p-bit));

At step 254, if the δ_{MCC-1,n} differs from the previous delta δ_{MCC-1,(n-1)}, the presence bit is set to 1, the delta value δ_{MCC-1,n} is stored into a field of length ┌Log₂ δ_{MCC-1,n-1┐ if ( Log}₂ δ_{MCC-1,(n-)}) is not an integer, otherwise the delta value is stored into a field of length ┌Log₂ δ_{MCC-1,n-}┐+1 and the rest of the PLMN-ID (the MNC component) is stored in a corresponding additional field (the total field length will be ┌Log₂ ≡_{MCC-1,n-1}┐ bits if (Log₂ δ_{MCC-1,(n-1)}) is not an integer, otherwise the total field length will be ┌Log₂ δ_{MCC-1,n-1}┐+1 bits, + the length required to store the MNC component +1 bit (for the p-bit)). At step 270, after the entire list has been processed, the PLMN-IDs are transmitted to one or plurality of mobile devices (WTRUs, mobile phones or other mobile devices, etc.).

Table 3 displays an example of the multiple PLMN-ID list (without the MNC component) when no zero-deltas exist between any MCCs and the MCC-1.

TABLE 3
Offset Field Reduction format with no zero-deltas
(without p-bit or MNC)

| Field value | Field length | Comment |
|---|---|---|
| MCC-1 | 10-bit | Greatest MCC value (No p-bit is |
| | | needed for the first entry) |
| δ_{MCC-1, 2} | ┌Log₂ MCC-1┐ if | Presence bit (p-bit) exists and set |
| | Log₂ MCC-1≠ integer, | (= 1). |
| | else ┌Log₂ MCC-1┐ +1 | If p-bit set, then MCC-2 = |
| | | MCC-1 − δ_{MCC-1, 2} ; |
| δ_{MCC-1, 3} | ┌Log₂δ_{MCC - 1,2}┐if | P-bit = 1; MCC-3 = MCC-1 − |
| | Log₂ δ_{MCC-1, 2} ≠ integer, | δ_{MCC-1, 3} ; |
| | else ┌Log₂δ_{MCC - 1,2}┐+1 | |
| ; ; ; | | P-bit = 1; MCC-3 = MCC-1 − |
| | | δ_{MCC-1, 3} ; |
| δ_{MCC-1, n} | ┌Log₂δ_{MCC - 1,n - 1}┐ if | MCC-n = MCC-1 − δ_{MCC-1, n} |
| | Log₂ δ_{MCC-1,(n-1)}≠ | |
| | integer, else | |
| | ┌Log₂δ_{MCC - 1,n - 1}┐+1 | |

The following is an example of multiple PLMN-ID (without the MNC component) list compression when a zero-delta exists between MCC-2 and MCC-1. The virtual representative of MCC-2 (i.e. the P-bit=0, see Table 4) is inserted between the MCC-1 and the MCC with the largest delta to MCC-1 (note the usage of the presence bit P-bit in the example). The p-bit rule for this method is as follows: if the p-bit right after MCC-1 is not set, then MCC-2==MCC-1, and so on, until the first p-bit is set. The field length is now ┌Log₂ MCC-1┐ if Log₂ MCC-1 is not an integer, otherwise the field length is ┌Log₂ MCC-1┐+1, plus the p-bit. Store δ_{MCC-1,n} into a field of length ┌Log₂ δ_{MCC-1,n-1}┐ if (Log₂ δ_{MCC-1,(n-1)}) is not an integer, otherwise store δ_{MCC-1,n} into a field of length ┌Log₂ δ_{MCC-1,n-1}┐+1, plus the p-bit.

TABLE 4
Offset Field Reduction format with zero-deltas (without MNC or p-bit)

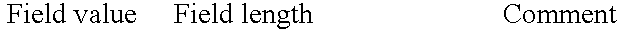

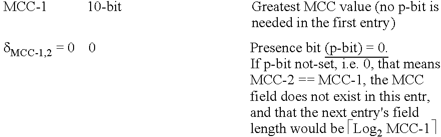

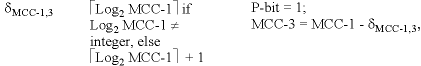

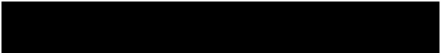

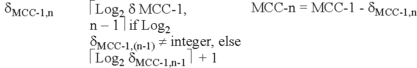

In Table 4, row 4 demonstrates that when the P-bit=0, MCC-3 and MCC-4 have the same MCC value and therefore the same delta value with respect to MCC-1. An example would be MCC-1=866, MCC-2=866, MCC-3=502, MCC-4=502. So with respect to MCC-1, the δ_{MCC-1,2}=0, the δ_{MCC-1,3}=364, the δ_{MCC-1,4}=364. So both deltas are equal to 384 (not zero). But the two deltas (364 vs. 364) are equal, so we can take advantage of this fact to further reduce multiple (with equal MCCs) PLMN-ID transmission by setting the p-bit=0. This instructs the mobile device (WTRU, mobile phone, etc.) to use the previous delta value, in deriving the MCC for this particular delta value, as shown in Table 5, row 4, below (in actual transmission, only Presence-bit is transmitted to the mobile device; the field length equal to zero (0) is derived by the rules previously set forth above):

TABLE 5

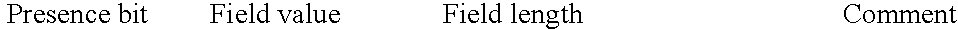

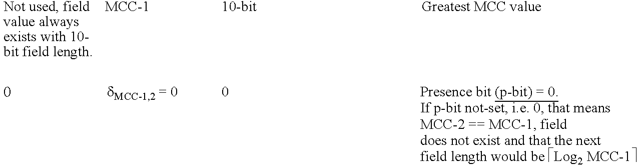

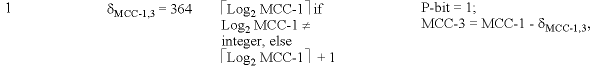

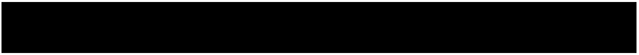

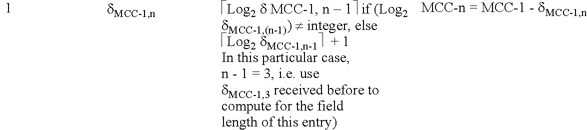

Given that certain methods, as set forth above, are applicable to particular combinations of PLMN-IDs and that the PLMN-IDs for network sharing in LTE are not often changed, the E-UTRAN may pre-test the PLMN-IDs using different compression methods, as set forth above, and publish the PLMN-IDs in the most efficient method appropriate to the given PLMN-IDs combinations. The E-UTRAN could announce the compression method (using a method indicator) in the system information block (SIB) broadcast together with the compressed multiple PLMN-IDs, so that the WTRUs in the cell know how to decode the network sharing PLMN-IDs.

Given that a MCC is unique, and given that there are less than 256 countries represented in the MCC lists, many values in the 3-digit MCC value range are not used. Therefore the MCC 3-digit value may be remapped into a new-MCC-entry-list of 256 or less, for example, 128, world-wide. Further, if that list can be divided by continent, then for each continent-MCC-entry-list, less that 128 values can be used.

TABLE 5
Remap the MCC value to an Entry List

| | | |
|---|---|---|
| Entry- | Original MCC | |
| Index | Value | Comment |

| | |
|---|---|
| 0 | MCC value 127 |
| 1 | MCC value 135 |
| 2 | MCC value 354 |
| 3 | MCC value 788 |
| ;; | |
| 127 | MCC value ??? |

The MCC values may be remapped to an Entry-List. In the multiple PLMN-ID list transmission, only the relevant Entry-Indexes may be used.

The same principles as described above equally apply to the MNC component of the PLMN-ID, i.e. the MNC may be similarly remapped into another entry-list and only the relevant MNC entry-index will be used in conjunction with the MCC entry-index for the transmission of multiple PLMN-IDs.

The aforementioned remapping methods may also be used in conjunction with the field length reduction techniques described above.

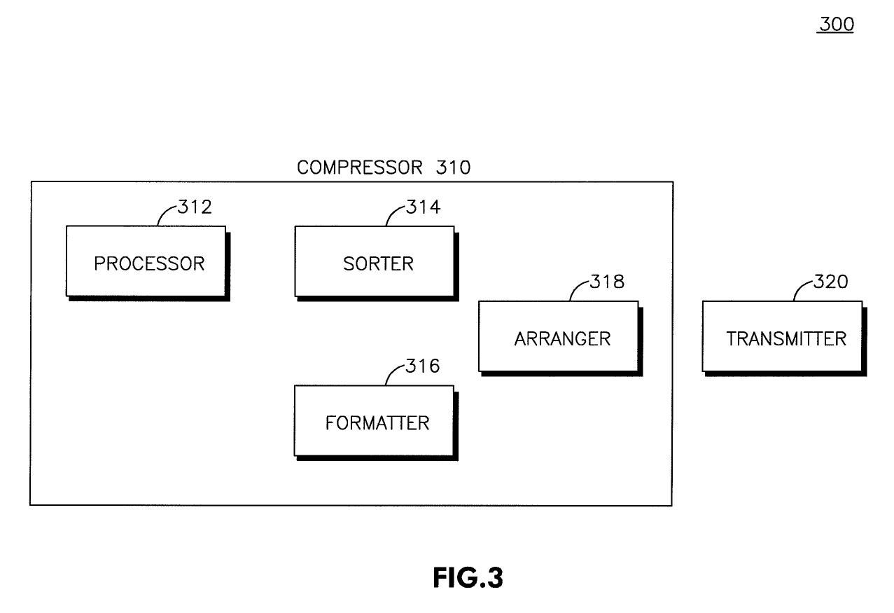

The aforementioned methods may be implemented in a variety of hardware devices. One implementation is in a an evolved Node-B (eNB) 300 shown in FIG. 3. The eNB 300 contains a compressor 310 and a transmitter 320. The eNB 300 obtains a list (typically from the network or a component of the network) of PLMN-IDs. The PLMN-IDs are passed to the compressor 310 which compresses one or both of the components of the PLMN-ID (MCC and MNC) according to the aforementioned techniques. The compressor 310 contains a processor 312, a sorter 314, a formatter 316 and an arranger 318. The processor 312 performs a variety of calculations and manipulation of PLMN-ID components and data. The sorter 314 sorts PLMN-ID components and data in ascending or descending order. The formatter 316 stores PLMN-ID components and data, into lists, tables, and any other data structure. These lists, tables, and any other data structures may reside in volatile memory, nonvolatile memory or any other type of storage device. The arranger 318 is configured to arrange PLMN-ID components and data, moving such information around within and among the previously described data structures (or within a new data structure).

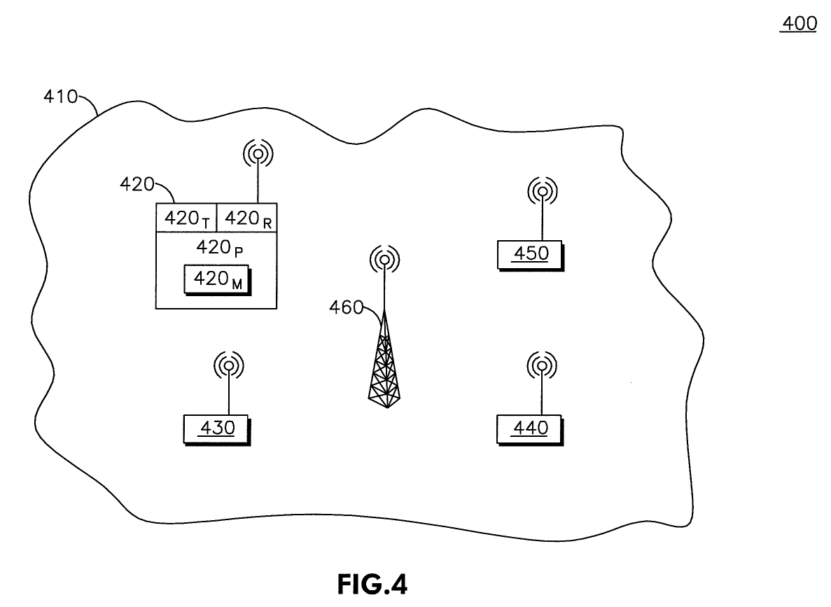

FIG. 4 illustrates an example of a wireless network 400 made up of WTRUs 420, 430, 440, 450 and an evolved Node B (eNB) 460 with the eNB's coverage area 410 being illustrated. WTRUs generally include various components such as a transmitter component 420_{T}, a receiver component 420_{R}, a processor component 420_{P} and a memory component 420_{M} which are illustrated with respect to WTRU 420. In this example, eNB 460 processes the PLMN-ID list according to the aforementioned methods and transmits a message containing an indication of the compression method and the compressed PLMN-ID list to any MD that requires the list such as MD 420. MD 420 receives the message containing the compression method indicator and compressed PLMN-ID list in its receiver 420_{R} and then the MD 420 processor 420_{P} stores the compressed PLMN-ID list into its memory 420_{M} and uses the compression indicator to “decode” the compression list.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method for optimizing the size of a wireless transmission comprising:
using a compression procedure on the wireless transmission that comprises a plurality of network identifiers (NI) wherein each NI further comprises a first component and a second component;
transmitting a compression procedure identifier; and
transmitting the compressed wireless transmission wherein at least one of a first component and a second component has been compressed.

2. The method of claim 1 wherein the compression procedure identifier and the wireless transmission are transmitted in a wireless transmission.

3. The method of claim 1 where the wireless transmission includes transmitting a plurality of NIs that are Public Land Mobile Network-Identifier (PLMN-ID)s that include a Mobile Country Code (MCC) as the first component and a Mobile Network Code (MNC) as a second component wherein the compression procedure compresses at least one of the MCC and the MNC.

4. The method of claim 3 wherein the compression procedure comprises:
sorting the PLMN-IDs in descending order based on the MCC code;
storing the PLMN-IDs in a first table;
storing the first PLMN-ID of the first table, using the largest possible MCC field length in a second table; and
storing the next PLMN-ID of the first table, including storing, as a compressed MCC, the MCC in a field length, derived from the MCC of the previous PLMN-ID of the first table, in the second table and storing the MNC in a corresponding entry of the second table.

5. The method of claim 3 wherein the compression procedure includes;
storing the MCC, as the compressed MCC, in a field of a length, derived from the MCC of the previous PLMN-ID of the first table, in a second table; and
storing the MNC in a respective field in the second table.

6. The method of claim 3 wherein a sum of all mobile country code (MCC) field lengths is
$$10 + {\sum }_{m = 1}^{n - 1} {Log}_{2} {MCC}_{m}$$
in wireless transmission of n MCCs.

7. The method of claim 3 wherein the compression procedure comprises:
setting MCC-1 to the value of the largest MCC code;
setting MCC-1 to the value of the largest MCC code having the largest corresponding MNC code, if there is more than one occurrence of the largest MCC code;
sorting the remaining MCC codes into a list in ascending order;
finding the difference between MCC-1 and each MCC in the list;
storing the difference in a delta table sorted in descending order if the difference is greater than 0;
storing the zero deltas in the front of the list; and
arranging a plurality of PLMN-IDs in a new table where the first PLMN-ID is the PLMN-ID containing MCC-1.

8. The method of claim 7 wherein the compression procedure further comprises arranging the remaining PLMN-IDs in the second table according to the order of their corresponding MCC in the delta table.

9. The method of claim 7 wherein the compression procedure further comprises a relationship wherein MCC-m is equal to MCC-1−δ_{MCC-1,m}, where n is the maximum number of MCC values and m is a number greater than or equal to 2 and less than or equal to n.

10. The method of claim 8 wherein the compression procedure further comprises:
storing the PLMN-ID containing MCC-1 into a field with a total field length of 10 bits plus the length of a second field required to store a MNC;
storing any PLMN-ID containing a zero-delta MCC into a field with a total field length of 1 bit plus the length of a second field required to store a MNC and setting the presence-bit (p-bit) to 0;
storing the first PLMN-ID containing a non-zero delta into a field with a total field length of 1 bit plus ┌Log₂ MCC-1┐ bits plus the length of a second field required to store a MNC and setting the p-bit to 1;
storing a subsequent PLMN-ID into a field with a total field length of 1 bit plus the length of a second field required to store a MNC and setting the presence-bit (p-bit) to 0, if δ_{MCC-1,n} equals the previous delta δ_{MCC-1,(n-1)}; and
storing the subsequent PLMN-ID into a field with a total field length of 1 bit plus ┌Log₂ δ_{MCC-1(n-1)} ┐ bits plus the length of a second field required to store a MNC and setting the p-bit to 1, if the δ_{MCC-1,n} differs from the previous delta δ_{MCC-1,(n-1)}.

11. The method of claim 4 wherein the compression procedure comprises, prior to sorting, reducing the list of available MCCs by remapping the MCCs into a table of used MCCs.

12. An evolved Node-B (eNB) for optimizing wireless transmission comprising:
a compressor configured to compress a wireless transmission that comprises a plurality of network identifiers (NI) wherein each NI further comprises a first component and a second component; and
a transmitter configured to transmit a compression procedure identifier; and
the transmitter further configured to transmit the compressed wireless transmission wherein at least one of a first component and a second component has been compressed.

13. The eNB of claim 12 wherein the transmitter is configured to transmit the compression procedure identifier and the compressed wireless transmission wherein at least one of a first component and a second component has been compressed.

14. The eNB of claim 12 wherein the transmitter is configured to transmit a plurality of NIs that are Public Land Mobile Network-Identifier (PLMN-ID)s that include a Mobile Country Code (MCC) as the first component and a Mobile Network Code (MNC) as a second component wherein the compressor compresses at least one of the MCC and the MNC.

15. The eNB of claim 14 wherein the compressor further comprises:
a processor configured to process PLMN-ID components, perform calculations and manipulate data;
a sorter configured to sort PLMN-ID components and data;
a formatter configured to store PLMN-ID components and data; and
an arranger configured to arrange PLMN-ID components and data.

16. The eNB of claim 15 wherein the sorter is configured to sort the PLMN-IDs in descending order based on the MCC code.

17. The eNB of claim 16 wherein the formatter is configured to store the PLMN-IDs in a first table, to store the first PLMN-ID of the first table, using the largest possible MCC field length in a second table, to store the next PLMN-ID of the first table, including storing, as a compressed MCC, the MCC in a field length, derived from the MCC of the previous PLMN-ID of the first table, in the second table and storing the MNC in a corresponding entry of the second table.

18. The eNB of claim 17 wherein the formatter is configured to store the MCC, as the compressed MCC, in a field of a length, derived from the MCC of the previous PLMN-ID of the first table, in a second table and store the MNC in a respective field in the second table.

19. The eNB of claim 18 wherein the processor is configured to set MCC-1 to the value of the largest MCC code, and set MCC-1 to the value of the largest MCC code having the largest corresponding MNC code, if there is more than one occurrence of the largest MCC code.

20. The eNB of claim 19 wherein the sorter is configured to sort the remaining MCC codes into a list in ascending order.

21. The eNB of claim 20 wherein the processor is configured to find the difference between MCC-1 and each MCC in the list.

22. The eNB of claim 21 wherein the formatter is configured to store the difference in a delta table sorted in descending order if the difference is greater than 0 and store storing the zero deltas in the front of the list.

23. The eNB of claim 22 wherein the arranger is configured to arrange a plurality of PLMN-IDs in a new table where the first PLMN-ID is the PLMN-ID containing MCC-1.

24. The eNB of claim 23 wherein the arranger is configured to arrange the remaining PLMN-IDs in the second table according to the order of their corresponding MCC in the delta table.

25. The eNB of claim 15 wherein the processor comprises a relationship such that MCC-m is equal to MCC-1−δ_{MCC-1,m}, where n is the maximum number of MCC values and m is a number greater than or equal to 2 and less than or equal to n.

26. The eNB of claim 24 wherein the formatter is configured to store the PLMN-ID containing MCC-1 into a field with a total field length of 10 bits plus the length of a second field required to store a MNC,
to store any PLMN-ID containing a zero-delta MCC into a field with a total field length of 1 bit plus the length of a second field required to store a MNC and setting the presence-bit (p-bit) to 0,
to store the first PLMN-ID containing a non-zero delta into a field with a total field length of 1 bit plus ┌Log₂ MCC-1┐ bits plus the length of a second field required to store a MNC and setting the p-bit to 1,
to store a subsequent PLMN-ID into a field with a total field length of 1 bit plus the length of a second field required to store a MNC and setting the presence-bit (p-bit) to 0, if δ_{MCC-1,n} equals the previous delta δ_{MCC-1,(n-1)}, and
to store the subsequent PLMN-ID into a field with a total field length of 1 bit plus ┌Log₂ δ_{MCC-1,(n-1)}┐ bits plus the length of a second field required to store a MNC and setting the p-bit to 1, if the δ_{MCC-1,n} differs from the previous delta δ_{MCC-1,(n-1)}.

27. The eNB of claim 15 wherein the processor is configured to reduce the list of available MCCs by remapping the MCCs into a table of used MCCs.

28. The method of claim 1 wherein the compression procedure is transmitted to a WTRU.

29. The eNB of claim 12 wherein the eNB is a Node-B.

30. A method for receiving a PLMN_ID list comprising:
receiving a message including a compression method indicator and compressed PLMN-IDs; and
processing the message further comprising:
storing the message; and
using the compression indicator to decompress the PLMN-IDS.

31. A wireless transmit and receive unit (WTRU) for receiving a Public Land Mobile Network-Identifier (PLMN-ID) list comprising:
a receiver configured to receive a message containing at least one of a compression indicator and a list containing compressed PLMN-IDs.
a processor configured to process the message; and
a memory configured to store the message.

32. The WTRU of claim 31 wherein the processor processes the message by using the compression indicator to decompress the PLMN-IDS.
